(19) United States
(12) Patent Application Publication
(10) Pub. No.: US 2015/0149547 A1
(43) Pub. Date: May 28, 2015

(54) INFORMATION PROCESSING SYSTEM AND INFORMATION PROCESSING DEVICE

(71) Applicant: Sharp Kabushiki Kaisha, Osaka (JP)

(72) Inventor: Hiroaki NAKAMURA, Osaka-shi (JP)

(21) Appl. No.: 14/492,293

(22) Filed: Sep. 22, 2014

(30) Foreign Application Priority Data
Nov. 27, 2013 (JP) 2013-245247

(51) Int. Cl. H04L 29/08

(52) U.S. Cl. CPC H04L 67/10
USPC 709/204

(57) ABSTRACT

The information processing system includes a mobile terminal device and an information processing device capable of bidirectionally transmit and receive information through short distance communication. The mobile terminal device includes a detection part detecting a physical quantity related to the posture or movement of the device itself, and a transmission part transmitting the detection information obtained by the detection performed at the detection part to the information processing device. The information processing device includes a reception part receiving detection information and a specifying part specifying transmission information to be transmitted to the mobile terminal device or reception information to be received from the mobile terminal device in accordance with the detection information received at the reception part.

### CROSS-REFERENCE TO RELATED APPLICATIONS

This Nonprovisional application claims priority under 35 U.S.C. §119(a) on Patent Application No. 2013-245247 filed in Japan on Nov. 27, 2013, the entire contents of which are hereby incorporated by reference.

### BACKGROUND

The present invention relates to an information processing system including a mobile terminal device and an information processing device that is capable of bidirectionally transmitting and receiving information through short-distance communication, and to the information processing device.

### DESCRIPTION OF THE RELATED ART

Between devices such as a mobile terminal device like a mobile phone or tablet device and an information processing device like a personal computer or display device, data transmission/reception is frequently performed. When, for example, moving data stored in a mobile terminal device to an information processing device, the information processing device is shown on a display screen of the mobile terminal device, and the stored data is designated with a cursor while an information processing device to which the data is moved is also designated with the cursor, to execute the processing of moving data. Moreover, in the case where information being referred to by a browser of a mobile terminal device is also displayed on an information processing device, the information is referred to by operating a keyboard on the information processing device to input the URL or the like of the information source.

Furthermore, an information processing device is disclosed, which moves data between different folders shown on a display, by designating one of the folders with a pen while operating a switch of the pen to take up data, and thereafter designating another one of the folders with the pen while operating the switch of the pen to release the data (see Japanese Patent Application Laid-Open No. 2004-54753).

### SUMMARY

When, however, movement or copying of data is performed in the device disclosed in Japanese Patent Application Laid-Open No. 2004-54753 or the conventional device, it is necessary for a user to perform operations of, for example, moving a cursor, inputting characters, or turning on/off a switch or the like, which can be cumbersome for the user.

The present invention has been made in view of the above circumstances. An object of the invention is to provide an information processing system capable of transmitting or receiving information with a simple operation, and an information processing device configuring the information processing system.

An information processing system according to the present invention including a mobile terminal device and an information processing device, both the mobile terminal device and the information processing device capable of bidirectionally transmitting and receiving information through short distance communication is characterized in that the mobile terminal device includes: a detection part detecting a physical quantity related to a posture or movement of the mobile terminal device itself; and a transmission part transmitting detection information obtained by detection performed by the detection part to the information processing device, and that the information processing device includes: a reception part receiving the detection information; and a specifying part specifying transmission information to be transmitted to the mobile terminal device or reception information to be received from the mobile terminal device in accordance with the detection information received by the reception part.

The information processing system according to the present invention is characterized in that the information processing device includes: a display part displaying a plurality of pieces of selection information respectively corresponding to a plurality of pieces of information; a selection part selecting one of the plurality of pieces of selection information displayed on the display part in accordance with the detection information, and that the specifying part is configured to specify information corresponding to the selection information selected by the selection part as the transmission information or the reception information.

The information processing system according to the present invention is characterized in that the information processing device includes: an information determination part determining whether or not information necessary for required processing is present; and a request part requesting the mobile terminal device for specifying information for specifying the selection information if the information determination part determines that the necessary information is not present, that the mobile terminal device is configured to transmit the specifying information to the information processing device when the request is made, that the information processing device is configured to further display the selection information on the display part based on the specifying information transmitted by the mobile terminal device, and that the specifying part is configured to specify the information corresponding to the selection information selected by the selection part as the reception information.

The information processing system according to the present invention is characterized in that the information processing device is configured to display the selection information on the display part if the information determination part determines that the necessary information is present, and that the specifying part is configured to specify the information corresponding to the selection information selected by the selection part as the transmission information.

The information processing system according to the present invention is characterized in that the information processing device includes a type specifying part specifying a type of the transmission information in accordance with the detection information received by the reception part.

The information processing system according to the present invention is characterized in that the information processing device includes: a display part capable of detecting a position in contact with the mobile terminal device on a display screen; and a display determination part determining whether or not information to be transmitted is being displayed at the position in contact with the mobile terminal device, and that the type specifying part is configured to specify the type if the display determination part determines that the information is being displayed.

The information processing system according to the present invention is characterized in that the information processing device includes a switch part switching between transmission of the transmission information and reception of the reception information in accordance with the detection information received by the reception part.

The information processing system according to the present invention is characterized in that the information processing device includes: a display part capable of detecting a position in contact with the mobile terminal device on a display screen; and a control part performing, when the switch part switches to transmit the transmission information, such control as to transmit information displayed at the position in contact with the mobile terminal device as the transmission information.

The information processing system according to the present invention is characterized in that the control part is configured to perform, when the switch part switches to receive the reception information, such control as to display the reception information at the position in contact with the mobile terminal device.

An information processing device capable of bidirectionally transmitting and receiving information to/from a mobile terminal device through short distance communication is characterized by including: a reception part receiving detection information related to a posture or movement of the mobile terminal device; and a specifying part specifying transmission information to be transmitted to the mobile terminal device or reception information to be received from the mobile terminal device in accordance with the detection information received by the reception part.

According to the present invention, information can be transmitted and received with a simple operation.

The above and further objects and features will more fully be apparent from the following detailed description with accompanying drawings.

### BRIEF DESCRIPTION OF THE DRAWINGS

FIG. 1 is a block diagram illustrating an example of a configuration of an information processing system according to the first embodiment;

FIG. 2 is an explanatory view illustrating an example of detection information;

FIG. 3 is an explanatory view illustrating an example of retained information;

FIG. 4 is an explanatory view illustrating an example of a location where information is retained;

FIG. 5 is an explanatory view illustrating the first example where menu information including selection information is displayed;

FIG. 6 is an explanatory view illustrating the second example where menu information including selection information is displayed;

FIG. 7 is a flowchart illustrating an example of a processing procedure performed by the information processing device according to the first embodiment;

FIG. 8 is a flowchart illustrating an example of a processing procedure performed by the information processing device according to the first embodiment;

FIG. 9 is a flowchart illustrating an example of a processing procedure performed by a mobile terminal device according to the first embodiment;

FIG. 10 is a flowchart illustrating an example of a processing procedure performed by the mobile terminal device according to the first embodiment;

FIG. 11 is a block diagram illustrating an example of a configuration of an information processing device according to the second embodiment;

FIG. 12 is a flowchart illustrating an example of a processing procedure performed by the information processing device according to the second embodiment;

FIG. 13 is a flowchart illustrating an example of a processing procedure performed by the information processing device according to the second embodiment;

FIG. 14 is a flowchart illustrating an example of a processing procedure performed by a mobile terminal device according to the second embodiment;

FIG. 15 is a block diagram illustrating an example of a configuration of an information processing device according to the third embodiment;

FIG. 16 is a flowchart illustrating an example of a processing procedure performed by the information processing device according to the third embodiment;

FIG. 17 is a flowchart illustrating an example of a processing procedure performed by the information processing device according to the third embodiment;

FIG. 18 is a flowchart illustrating an example of a processing procedure performed by a mobile terminal device according to the third embodiment; and

FIG. 19A-19D is a schematic view illustrating an example of transmission/reception of information in the information processing system according to the third embodiment.

### DETAILED DESCRIPTION

### First Embodiment

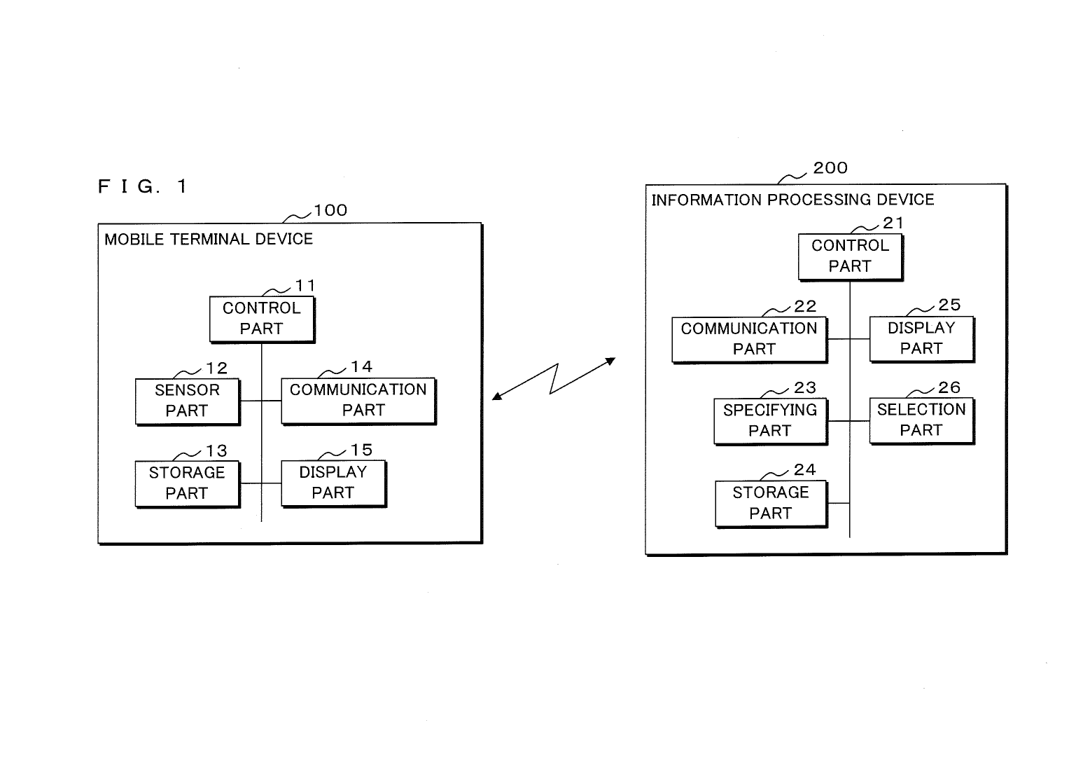

The present invention will now be described with reference to the drawings illustrating the embodiments thereof. FIG. 1 is a block diagram illustrating an example of a configuration of an information processing system according to the first embodiment. As illustrated in FIG. 1, the information processing system according to the first embodiment includes, for example, a mobile terminal device 100 and an information processing device 200. The mobile terminal device 100 is, for example, a mobile phone, a smartphone or a tablet device, which may be held by a user to perform a predetermined operation. The information processing device 200 is, for example, a display device such as a personal computer or a display. The mobile terminal device 100 and information processing device 200 can bidirectionally transmit and receive information through non-contact communication such as NFC (Near Field Communication) or short distance wireless communication such as Bluetooth (registered trademark). It is noted that the wireless communication system is not limited to the above.

The mobile terminal device 100 includes a control part 11, a sensor part 12, a storage part 13, a communication part 14, a display part 15 and the like. The information processing device 200 includes a control part 21, a communication part 22, a specifying part 23, a storage part 24, a display part 25, a selection part 26 and the like.

The control part 11 is configured by a CPU or the like, and controls the entire mobile terminal device 100.

The sensor part 12 has a function as a detection part. When the user holds the mobile terminal device 100 and changes the posture of or moves the mobile terminal device 100, the sensor part 12 detects a physical quantity related to the posture or movement of the mobile terminal device 100. The sensor part 12 includes, for example, an inclination sensor, an acceleration sensor and a geomagnetic sensor, and is able to detect the inclination, direction, orientation (vertical or horizontal, for example) and the like with respect to the posture of the mobile terminal device 100. Moreover, the sensor part 12 is able to detect the rotation direction, vibration amount, moving direction and the like with respect to the movement of the mobile terminal device 100. The sensor part 12 outputs the detected physical quantity to the control part 11.

The communication part 14 has functions of non-contact communication and short distance wireless communication, and functions as a transmission part. Under the control of the control part 11, the communication part 14 transmits detection information obtained by detection performed by the sensor part 12 to the information processing device 200.

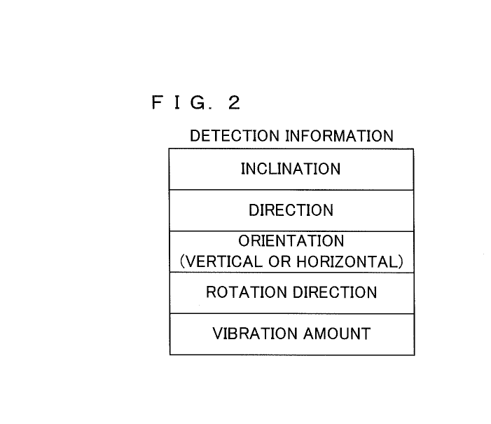

FIG. 2 is an explanatory view illustrating an example of detection information. As illustrated in FIG. 2, the detection information includes the inclination, direction and orientation (vertical or horizontal), rotation direction, vibration amount and the like of the mobile terminal device 100. Furthermore, the detection information may also include the moving direction of the mobile terminal device 100.

The storage part 13 may store information necessary for required processing performed in the information processing device 200. The information necessary for required processing corresponds to, for example, the information necessary for the operation to be executed by the user or for execution of a required application, which is determined in advance. The storage part 13 may store information to be transmitted from the mobile terminal device 100 to the information processing device 200, or the information transmitted by the information processing device 200.

The display part 15 includes, for example, a liquid crystal display panel, which can display information.

The control part 21 is configured with a CPU or the like, and controls the entire information processing device 200.

The communication part 22 has functions of non-contact communication and short distance wireless communication, and functions as a reception part. The communication part 22 receives the detection information transmitted by the mobile terminal device 100, and outputs the received detection information to the specifying part 23.

The specifying part 23 specifies transmission information to be transmitted to the mobile terminal device 100 or reception information to be received from the mobile terminal device 100 in accordance with the detection information received by the communication part 22. The transmission information or reception information corresponds to information on, for example, a document file, an image file, an address (e.g., WEB address, electric mail address, network address) or a place of contact.

Accordingly, both in the cases where information is transmitted from the information processing device 200 to the mobile terminal device 100 and where information is received by the information processing device 200 from the mobile terminal device 100, the information can be specified in accordance with the posture or movement of the mobile terminal device 100 operated by the user. This eliminates the need for the operation of, for example, moving a cursor, inputting characters or turning on/off a switch or the like, allowing the user to transmit/receive required information with a simple operation by merely changing the posture or movement of the mobile terminal device 100, and thus to have enhanced convenience.

The control part 21 has a function as an information determination part, and determines whether or not information necessary for required processing is present by referring to the storage part 24. The information necessary for required processing corresponds to, for example, the information necessary for the operation to be executed by the user or for execution of a required application, which is determined in advance. Determination on the presence of the information is to determine whether or not the information processing device 200 stores (retains) the necessary information.

Furthermore, the control part 21 has a function as a request part, and if it is determined that necessary information is not stored (retained) in the storage part 24, makes a request for retained information (specifying information) for specifying selection information to the mobile terminal device 100.

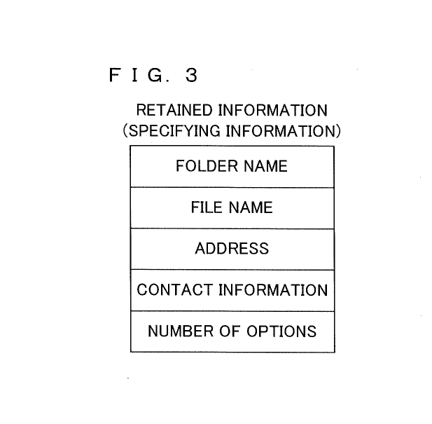

FIG. 3 is an explanatory view illustrating an example of retained information. The retained information (also referred to as “specifying information”) is the information for specifying selection information and may also be used as selection information. The specifying information includes, for example, a folder name, a file name, an address, contact information or the number of options.

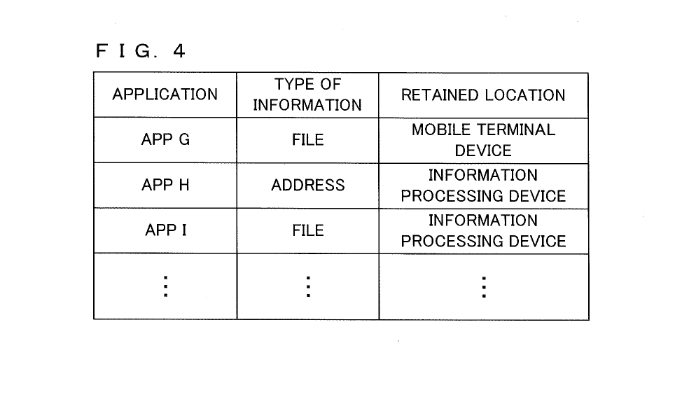

FIG. 4 is an explanatory view illustrating an example of a location where information is retained. As illustrated in FIG. 4, for each application which can be executed in the information processing device 200, the type of information used in the application and the location where the information is retained are pre-stored in the storage part 24 by associating them with each other.

For example, in the case where the processing to be executed by the user is an application G (App G), the type of information necessary for the processing is a file, and the location where the information necessary for App G is retained is in the mobile terminal device 100. When the information is a file, the selection information (retained information, specifying information) used for selecting a file can be set as a file name.

Similarly, in the case where the processing to be executed by the user is an application H (App H), the type of information necessary for the processing is an address, and the location where the information necessary for App H is retained is in the information processing device 200. When the information is an address, the selection information (retained information, specifying information) used for selecting an address can be set as an address itself.

Likewise, in the case where the processing to be executed by the user is an application I (App I), the type of information necessary for the processing is a file, and the location where the information necessary for App I is retained is in the information processing device 200. When the information is a file, the selection information (retained information, specifying information) used for selecting a file can be set as a file name.

The display part 25 includes, for example, a liquid-crystal display panel, which can display information.

Under the control of the control part 21, the display part 25 displays multiple pieces of selection information respectively corresponding to multiple pieces of information. When, for example, the information is a file, the selection information is a file name for selecting the file. In other words, the display part 25 may display menu information including multiple pieces of selection information for selecting multiple pieces of information.

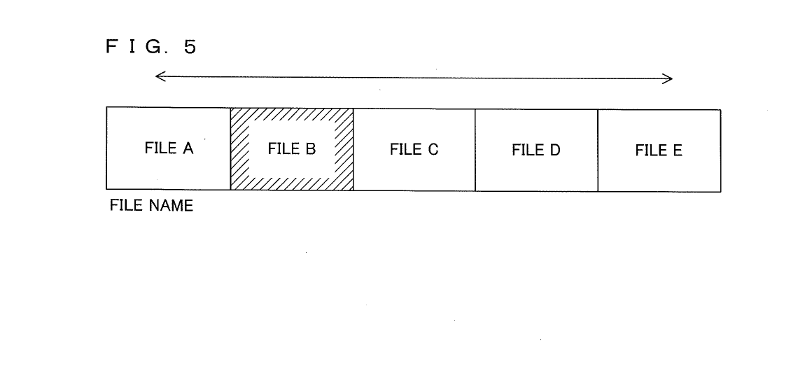

FIG. 5 is an explanatory view illustrating the first example where menu information including selection information is displayed. As illustrated in FIG. 5, the display part 25 displays, as file names corresponding to the selection information, five file names from a file A to a file E arranged side by side in the horizontal direction. In the example of FIG. 5, the menu information is the information in which the five file names are displayed in a selectable manner. The selection part 26 selects one of the multiple pieces of selection information displayed on the display part 25 in accordance with the detection information. When, for example, the user holds and tilts the mobile terminal device 100 to the right side, the five file names illustrated in FIG. 5 are selected in the order toward the right direction. In the example of FIG. 5, the file B is displayed differently from other file names, which indicates that the file B is selected. Similarly, when the user holds and tilts the mobile terminal device 100 to the left side, the five file names illustrated in FIG. 5 are selected in the order toward the left direction.

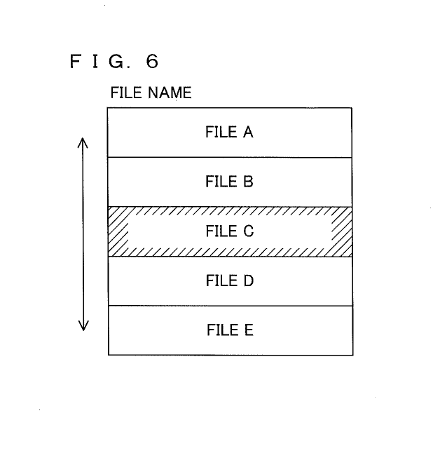

FIG. 6 is an explanatory view illustrating the second example where menu information including selection information is displayed. As illustrated in FIG. 6, the display part 25 shows five file names from a file A to a file E arranged in the vertical direction as the file names for selection information. In this case, when, for example, the user holds the mobile terminal device 100 and moves it upward, the five file names illustrated in FIG. 6 are selected in the order toward the upper direction. The example of FIG. 6 shows that the file C is selected by displaying the file C differently from other file names. Similarly, when the user holds and moves the mobile terminal device 100 downward, the five file names illustrated in FIG. 6 are selected in the order toward the lower direction. Note that the display example of the menu information including the selection information is not limited to the examples of FIGS. 5 and 6.

Accordingly, the selection part 26 is able to convert the posture or movement of the mobile terminal device 100 into the operation of selecting the displayed multiple pieces of selection information in accordance with the posture or movement thereof.

The specifying part 23 then specifies information corresponding to the selection information selected by the selection part 26 as transmission information or reception information. This allows the user, when selecting required selection information from the displayed multiple pieces of selection information by changing the posture or movement of the mobile terminal device 100, to transmit information corresponding to the selected selection information to the mobile terminal device 100 or to receive such information from the mobile terminal device 100. Accordingly, the user can select required information with a simple operation and can also transmit or receive the selected information.

Furthermore, as described earlier, in the case where the control part 21 determines that necessary information is not stored (not retained) in the storage part 24 and requests the mobile terminal device 100 for retained information (specifying information), the mobile terminal device 100 transmits the specifying information stored (retained) in advance in the storage part 13 to the information processing device 200. The information processing device 200 then displays selection information on the display part 25 based on the specifying information transmitted by the mobile terminal device 100.

The information processing device 200 can display, for example, the specifying information received from the mobile terminal device 100 as selection information on the display part 25. As illustrated in FIGS. 5 and 6, for example, when receiving more than one file names as specifying information, the information processing device 200 can display the received file names as selection information. When holding the mobile terminal device 100 and changing its posture or moving it, the user can select a desired piece of selection information in accordance with the posture or movement. The specifying part 23 specifies the information corresponding to the selection information selected by the selection part 26 as reception information. Accordingly, when the user performs required processing, by changing the posture or movement of the mobile terminal device 100 and thereby selecting required selection information from the displayed multiple pieces of selection information, the user can receive information corresponding to the selected selection information from the mobile terminal device 100, even if the information is not retained in the information processing device 200.

Furthermore, if the control part 21 determines that necessary information is stored (retained) in the storage part 24, the information processing device 200 displays selection information on the display part 25 without requesting the mobile terminal device 100 for specifying information. In other words, in the case where the information processing device 200 stores (retains) information necessary for required processing in the storage part 24 in advance, the specifying information retained by itself is displayed as selection information. When holding the mobile terminal device 100 and changing its posture or moving it, the user can select desired selection information in accordance with the posture or movement. The specifying part 23 specifies the information corresponding to the selection information selected by the selection part 26 as transmission information.

Accordingly, when the user performs required processing, by changing the posture or movement of the mobile terminal device 100 and thereby selecting required selection information from the displayed multiple pieces of selection information, the user can transmit information corresponding to the selected selection information to the mobile terminal device 100 even if the information is not retained in the mobile terminal device 100.

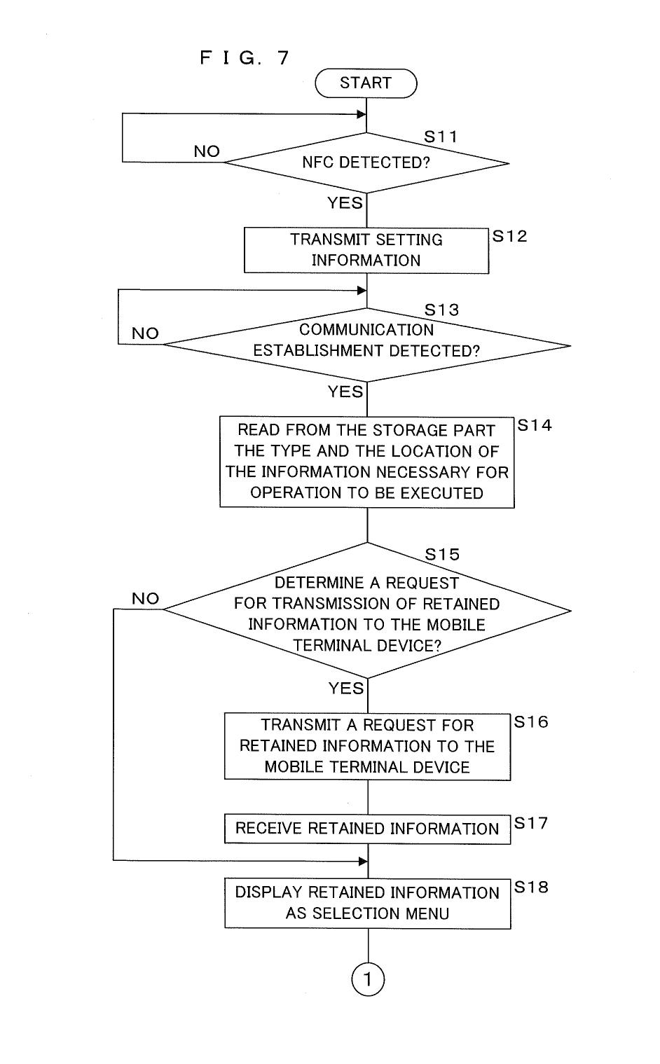

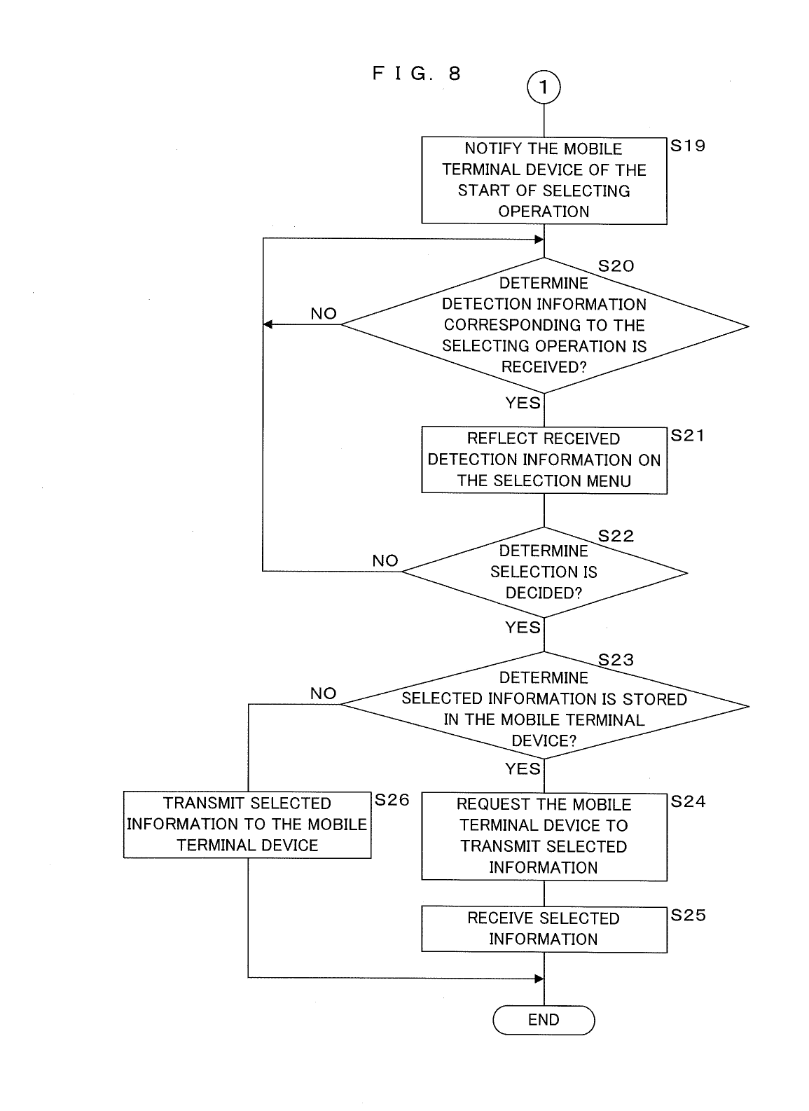

Next, the operation of the information processing system according to the first embodiment is described. FIGS. 7 and 8 show a flowchart illustrating an example of a processing procedure performed by the information processing device 200 according to the first embodiment. For the sake of convenience, the control part 21 is described as the subject of the processing in the following.

The control part 21 determines whether or not NFC detection is performed (S11). By the user moving the mobile terminal device 100 closer to the information processing device 200, the control part 21 can perform NFC detection. If the NFC detection is not performed (NO at S11), the control part 21 continues the processing of step S11.

If the NFC detection is performed (YES at S11), the control part 21 transmits setting information for performing short distance wireless communication such as Bluetooth (S12). The control part 21 determines whether or not the establishment of communication is detected (S13), and if the establishment of communication is not detected (NO at S13), continues the processing of step S13. It is noted that the establishment of short distance wireless communication eliminates the need for the user to constantly place the mobile terminal device 100 close to the information processing device 200, and thus the user can be away from the information processing device 200 as long as he/she is within an area where the short distance wireless communication is possible, which enhances the convenience for the user.

When the establishment of communication is detected (YES at S13), the control part 21 reads out from the storage part 24 the type and the location of the information necessary for an operation to be executed (S14), and determines whether or not a request for transmission of retained information is made to the mobile terminal device 100 (S15). If the information processing device 200 stores the required retained information, it is not necessary to make a request for retained information. If, however, the information processing device 200 does not store the required retained information, it is necessary to make a request for the retained information.

If a request for transmitting retained information is to be made (YES at S15), the control part 21 transmits a request for retained information to the mobile terminal device 100 (S16), and receives the retained information transmitted by the mobile terminal device 100 (S17). If a request for transmitting retained information is not made (NO at S15), the control part 21 skips the processing of steps S16 and S17, and performs the processing of step S18, which will be described later.

The control part 21 displays the retained information as a selection menu (menu information) (S18), and notifies the mobile terminal device 100 of the start of selecting operation (S19). The notification of the start of selecting operation is displayed on the display part 15 of the mobile terminal device 100, allowing the user to recognize that the selecting operation may be performed. Accordingly, the user can select desirable retained information (specifying information) from the selection menu by holding the mobile terminal device 100 and changing its posture or moving it.

The control part 21 determines whether or not detection information corresponding to the selecting operation is received (S20), and if the detection information is not received (NO at S20), continues the processing of step S20. If the detection information is received (YES at S20), the control part 21 reflects the received detection information on the selection menu, as illustrated in FIGS. 5 and 6 (S21). In this case, the control part 21 specifies the one with a large amount of variation (or numeric value) among the received detection information as the posture or movement of the mobile terminal device 100. For example, in the case where a physical quantity related to a direction and a physical quantity related to an inclination are obtained as detection information, if the physical quantity related to a direction is larger than the physical quantity related to an inclination, it can be determined that the direction of the mobile terminal device 100 is the one that is changed.

The control part 21 determines whether or not a selection is decided (S22). It is noted that the determination on whether or not a selection is decided can be made based on whether or not a preset operation is performed at the mobile terminal device 100. For example, an operation of lightly shaking the mobile terminal device 100 once may be set as the preset operation.

If the selection is not decided (NO at S22), the control part 21 repeats the processing at and after step S20. If the selection is decided (YES at S22), the control part 21 determines whether or not the selected information is stored in the mobile terminal device 100 (S23). If the information processing device 200 stores required retained information, it may be determined that the selected information is not stored in the mobile terminal device 100. If, on the other hand, the information processing device 200 does not store necessary retained information, it may be determined that the selected information is stored in the mobile terminal device 100.

If the selected information is stored in the mobile terminal device 100 (YES at S23), the control part 21 requests the mobile terminal device 100 to transmit the selected information (S24), receives the selected information that has been transmitted by the mobile terminal device 100 (S25), and terminates the processing. If the selected information is not stored in the mobile terminal device 100 (NO at S23), that is, if the selected information is stored in the information processing device 200, the control part 21 transmits the selected information to the mobile terminal device 100 (S26), and terminates the processing.

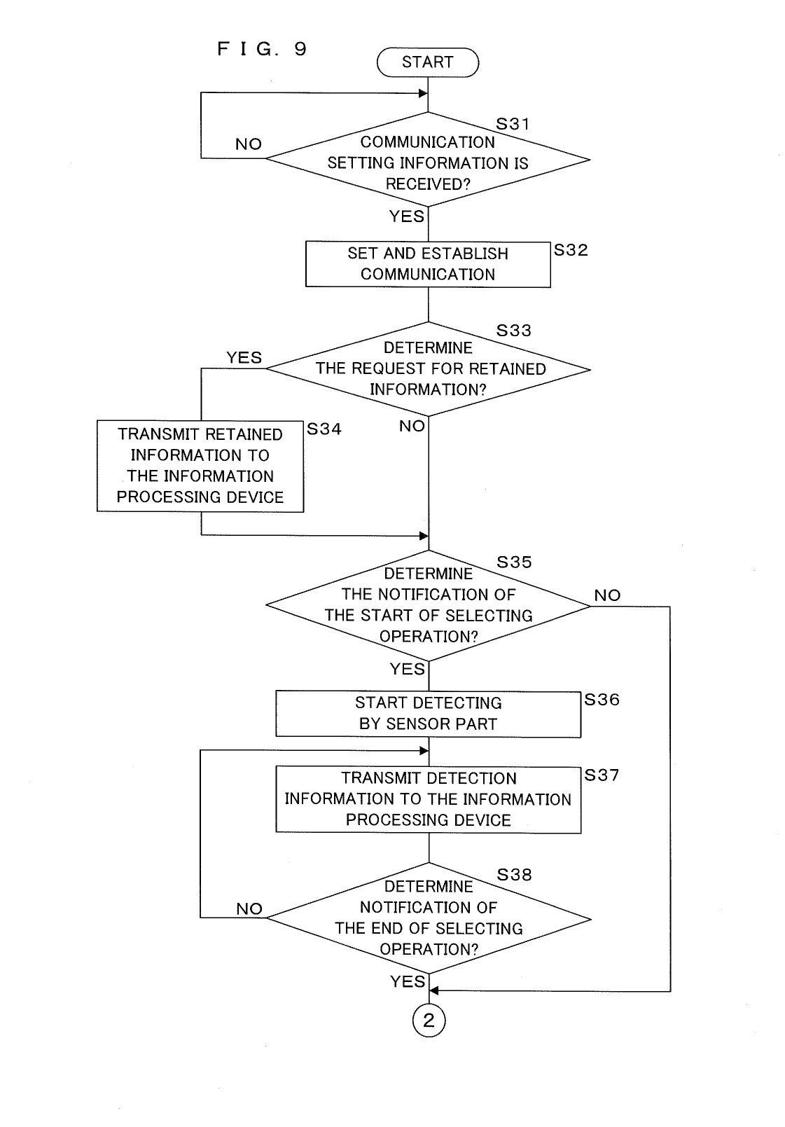

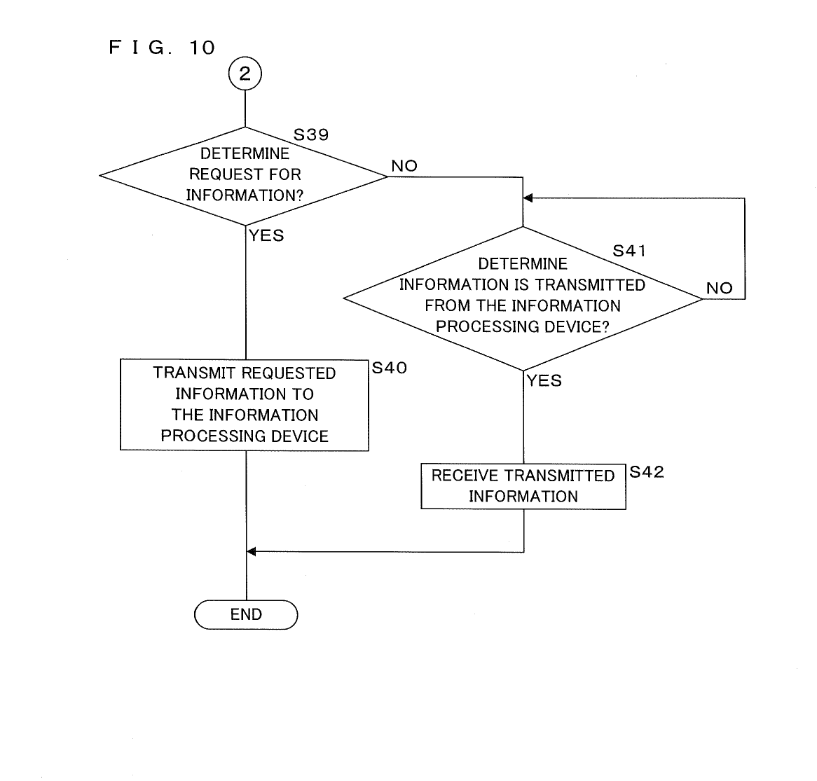

FIGS. 9 and 10 show a flowchart illustrating an example of a processing procedure performed by the mobile terminal device 100 according to the first embodiment. For the sake of convenience, the control part 11 is described as the subject of processing in the following. The processing as shown in FIGS. 9 and 10 correspond to the processing as shown in FIGS. 7 and 8.

The control part 11 determines whether or not communication setting information is received from the information processing device 200 (S31), and if the communication setting information is not received (NO at S31), continues the processing of step S31. If the communication setting information is received (YES at S31), the control part 11 sets and establishes the communication (S32), and determines whether or not the request for retained information is made from the information processing device 200 (S33).

If a request for retained information is made (YES at S33), the control part 11 transmits the retained information pre-stored in the storage part 13 to the information processing device 200 (S34). If a request for retained information is not made (NO at S33), the control part 11 skips the processing of step S34 and performs the processing of step S35 which will be described later.

The control part 11 determines whether or not the notification of the start of the selecting operation is issued (S35), and if the notification of the start of the selecting operation is issued (YES at S35), starts detecting a predetermined physical quantity (e.g., the inclination, direction, orientation, rotation direction, vibration amount, moving direction or the like of the mobile terminal device 100) by the sensor part 12 (S36). By the user holding the mobile terminal device 100 and changing its posture or moving it, the sensor part 12 can detect a predetermined physical quantity. The control part 11 transmits the detection information obtained by the detection performed by the sensor part 12 to the information processing device 200 (S37).

The control part 11 determines whether or not a notification of the end of the selecting operation is issued (S38). The notification of the end of the selecting operation may be made by issuing a notification indicating that the selection is decided when the selection is decided at the information processing device 200. It is noted that, when more than one options are selected, the notification of the end of the selecting operation may be issued by means of an operation different from that for deciding the selection.

If a notification of the end of the selecting operation is not issued (NO at S38), the control part 11 continues the processing at and after step S37. If a notification of the end of the selecting operation is issued (YES at S38), the control part 11 determines whether or not a request for information is made from the information processing device 200 (S39). Furthermore, at step S35, if a notification of the start of the selecting operation is not issued (NO at S35), the control part 11 performs the processing of step S39.

If a request for information is made (YES at S39), the control part 11 transmits the requested information to the information processing device 200 (S40), and terminates the processing. If a request for information is not made (NO at S39), the control part 11 determines whether or not the information is transmitted from the information processing device 200 (S41), and if the information is not transmitted (NO at S41), repeats the processing of step S41. If the information is transmitted (YES at S41), the control part 11 receives the transmitted information (S42) and terminates the processing.

### Second Embodiment

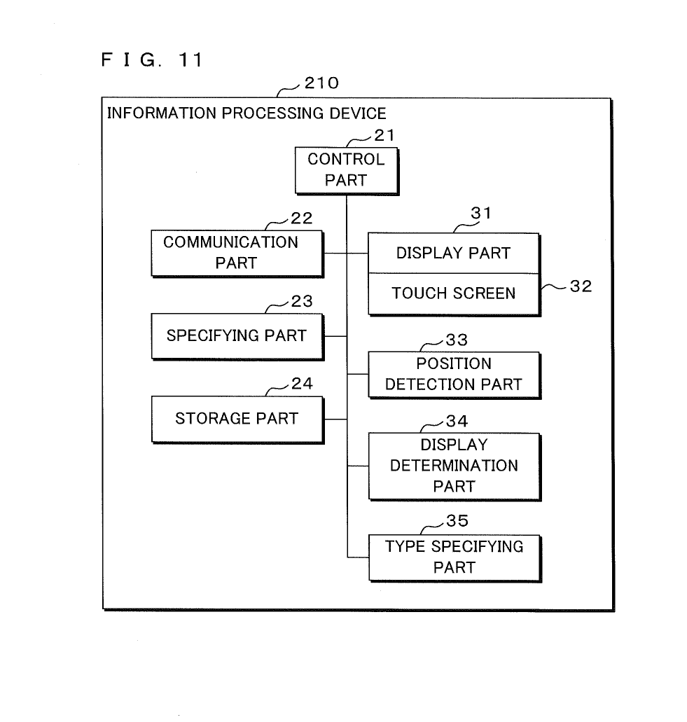

FIG. 11 is a block diagram illustrating an example of a configuration of an information processing device 210 according to the second embodiment. The information processing device 210 according to the second embodiment is different from the information processing device 200 according to the first embodiment in that it further includes a display part 31, a touch screen (touch panel) 32, a position detection part 33, a display determination part 34, a type specifying part 35 and the like. The mobile terminal device 100 is similar to that in the first embodiment. The parts similar to those in the first embodiment are denoted by the same reference numbers and will not be described in detail.

The type specifying part 35 specifies the type of transmission information in accordance with the detection information received by the communication part 22. For example, as for the type of information, when the information is divided into a document file and an image file, different postures or movements of the mobile terminal device 100 are set to be associated with a document file and an image file, respectively. For example, an image file may be associated when the mobile terminal device 100 is inclined to be horizontal, whereas a document file may be associated when the mobile terminal device 100 is inclined to be vertical. This allows the user to change the content of information to be transmitted with a simple operation by changing the posture or movement of the mobile terminal device 100.

The display part 31 and touch screen 32 are configured to be able to detect a position which is in contact with the mobile terminal device 100 on a display screen. The display part 31 and touch screen 32 may be, for example, a liquid crystal panel provided with a touch screen or a touch screen device with a light emitting part and a light receiving part arranged around the display screen.

The display determination part 34 determines whether or not information to be transmitted to the mobile terminal device 100 is displayed at the position which is in contact with the mobile terminal device 100. The type specifying part 35 can specify the type of transmission information when the display determination part 34 determines that information is displayed.

In other words, with a simple operation by the user holding the mobile terminal device 100 and making the mobile terminal device 100 in contact with a position of the information displayed on the display screen of the information processing device 210, different types of information may be transmitted to the mobile terminal device 100 in accordance with the posture or movement of the mobile terminal device 100.

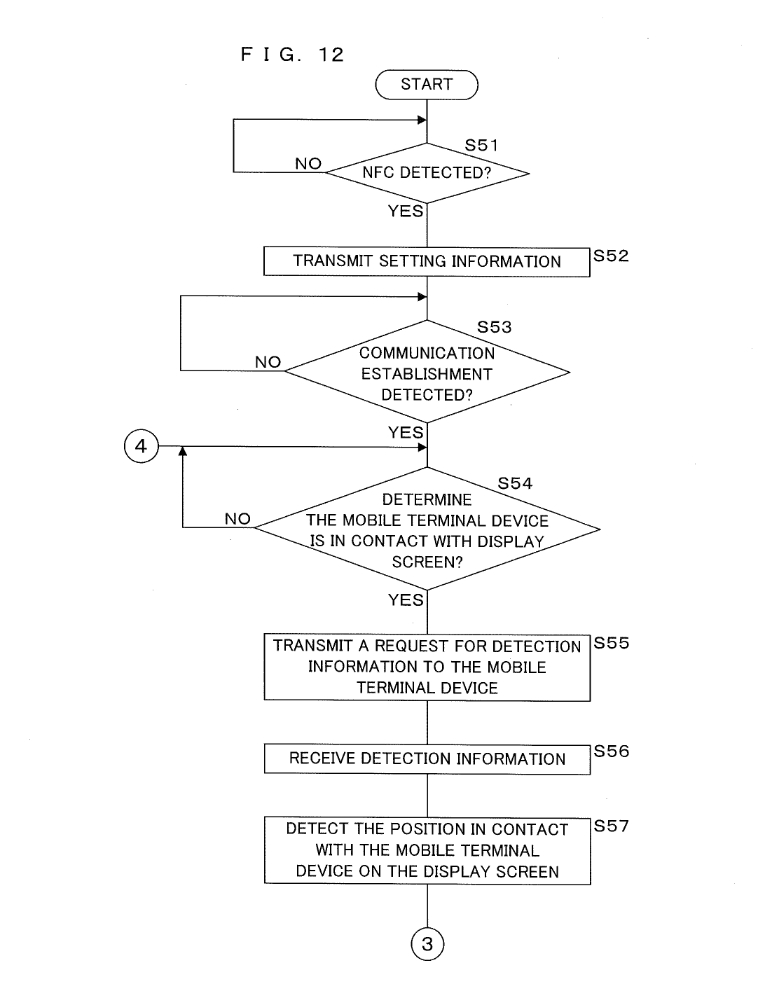

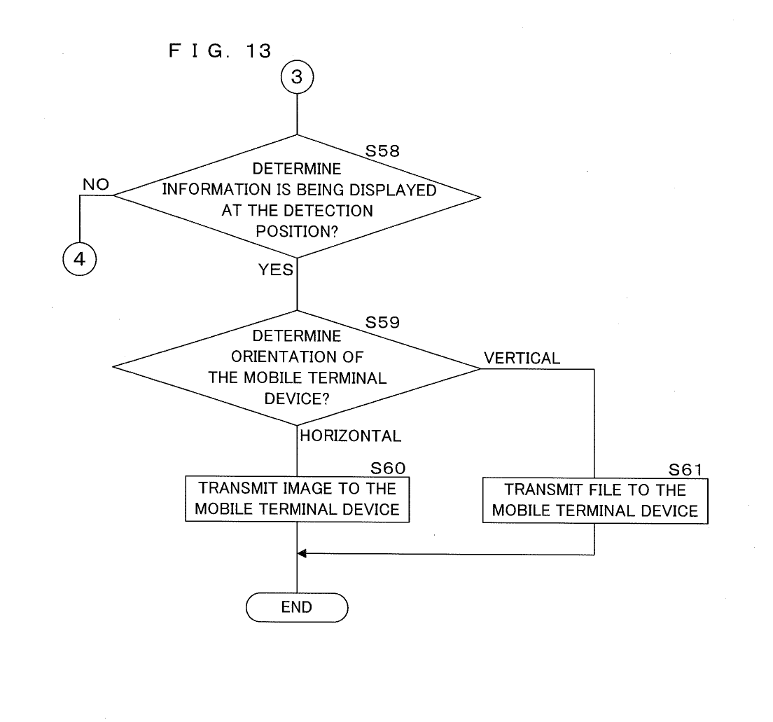

Next, the operation of the information processing system according to the second embodiment is described. FIGS. 12 and 13 show a flowchart illustrating an example of a processing procedure performed by the information processing device 210 according to the second embodiment. For the sake of convenience, the control part 21 is described below as the subject of processing.

The control part 21 determines whether or not NFC detection is performed (S51). By the user moving the mobile terminal device 100 closer to the information processing device 210, the control part 21 can perform NFC detection. If the NFC detection is not performed (NO at S51), the control part 21 continues the processing of step S51.

If the NFC detection is performed (YES at S51), the control part 21 transmits setting information for performing short distance wireless communication such as Bluetooth (S52). The control part 21 determines whether or not the establishment of communication is detected (S53), and if the establishment of communication is not detected (NO at S53), continues the processing of step S53.

If the establishment of communication is detected (YES at S53), the control part 21 determines whether or not the mobile terminal device 100 is in contact with the display screen (S54). It is noted that the determination is not limited to be made based on the state of contact but may also be made based on the state of proximity. If the mobile terminal device 100 is not in contact with the display screen (NO at S54), the control part 21 continues the processing of step S54.

If the mobile terminal device 100 is in contact with the display screen (YES at S54), the control part 21 transmits a request for detection information to the mobile terminal device 100 (S55), and receives the detection information transmitted by the mobile terminal device 100 (S56).

The control part 21 detects the position on the display screen which is in contact with the mobile terminal device 100 (S57). The control part 21 determines whether or not information is being displayed at the detected position on the display screen (S58). If no information is being displayed at the detected position (NO at S58), the control part 21 performs processing at and after S54.

If information is being displayed at the detected position (YES at S58), the control part 21 determines the orientation of the mobile terminal device 100 (S59). If the mobile terminal device 100 is horizontally oriented (horizontal at S59), the control part 21 transmits an image (image file), among the information being displayed, to the mobile terminal device 100 (S60), and terminates the processing. If the mobile terminal device 100 is vertically oriented (vertical at S59), the control part 21 transmits a file (document file), among the information being displayed, to the mobile terminal device 100 (S61), and terminates the processing.

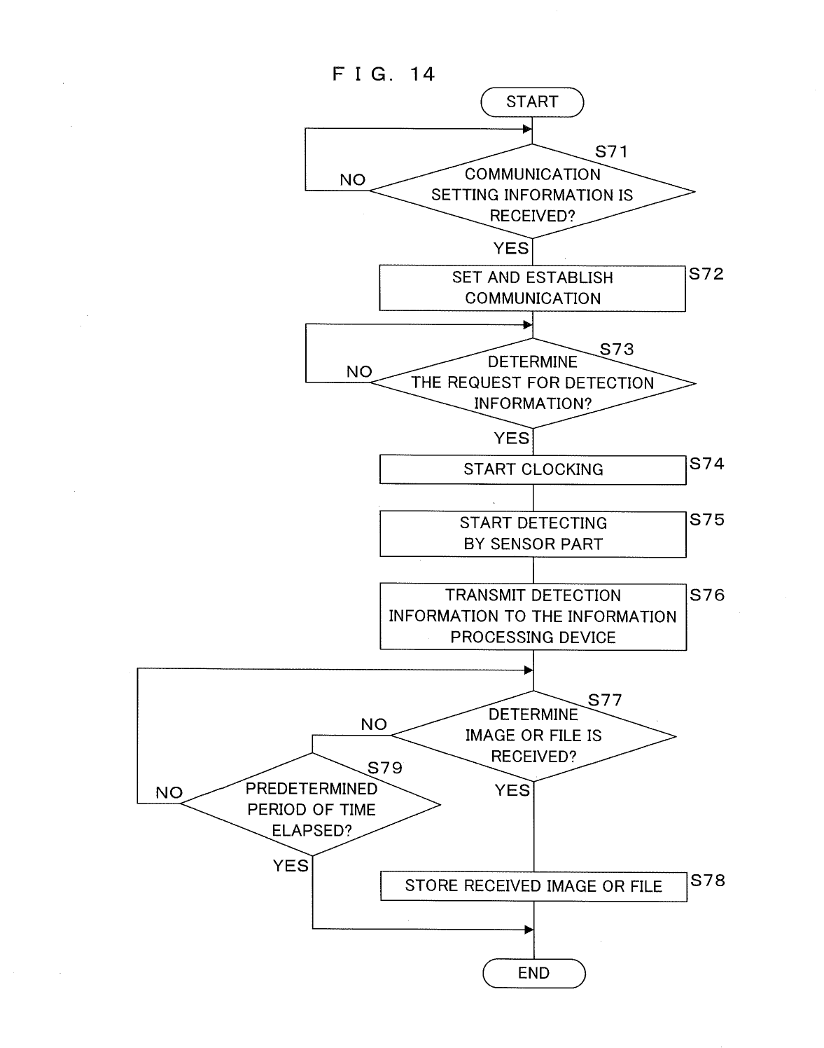

FIG. 14 is a flowchart illustrating an example of a processing procedure performed by mobile terminal device 100 according to the second embodiment. For the sake of convenience, the control part 11 is described as the subject of processing in the following description. The processing shown in FIG. 14 corresponds to the processing shown in FIGS. 12 and 13.

The control part 11 determines whether or not communication setting information is received from the information processing device 210 (S71), and if the communication setting information is not received (NO at S71), continues the processing of step S71. If the communication setting information is received (YES at S71), the control part 11 sets and establishes communication (S72), and determines whether or not a request for detection information is made from the information processing device 210 (S73).

If a request for detection information is not made (NO at S73), the control part 11 continues the processing of step S73. If a request for detection information is made (YES at S73), the control part 11 starts clocking (S74) and also starts detection of a predetermined physical quantity (e.g., orientation of the mobile terminal device 100) by the sensor part 12 (S75). The control part 11 transmits the detection information obtained by detection performed by the sensor part 12 to the information processing device 200 (S76).

The control part 11 determines whether or not an image (image file) or a file (document file) is received (S77), and if received (YES at S77), stores the received image or file in the storage part 24 (S78) and terminates the processing.

If an image or a file is not received (NO at S77), the control part 11 determines whether or not a predetermined period of time has elapsed from the time at which clocking is started (S79), and if the predetermined period of time has not elapsed (NO at S79), performs the processing at and after step S77. If, on the other hand, the predetermined period of time has elapsed (YES at S79), the control part 11 terminates the processing.

### Third Embodiment

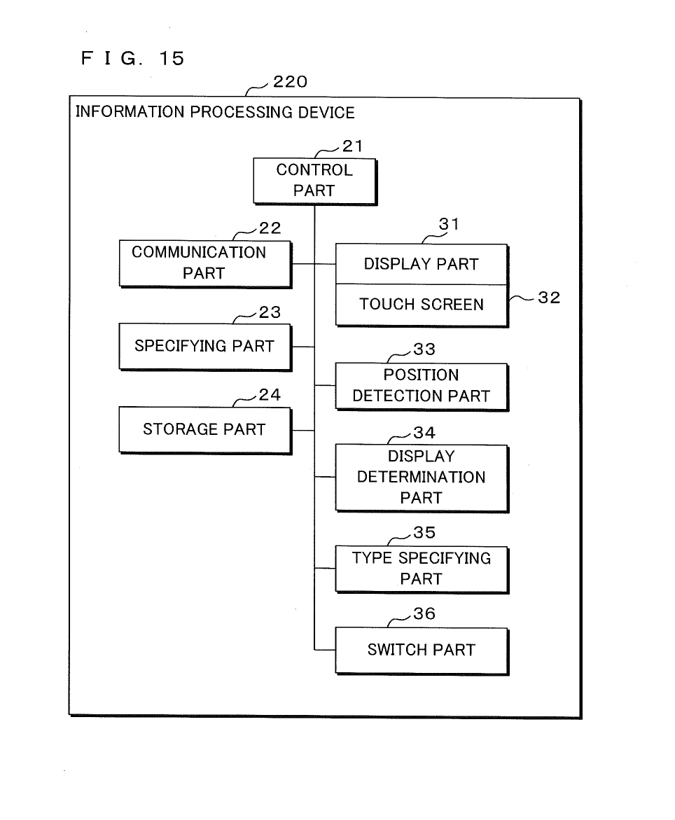

FIG. 15 is a block diagram illustrating an example of a configuration of an information processing device 220 according to the third embodiment. The information processing device 220 according to the third embodiment is different from the information processing device 210 according to the second embodiment in that it includes a switch part 36 in place of the type determination part 35. The mobile terminal device 100 is similar to that in the second embodiment. Moreover, parts similar to those in the second embodiment are denoted by the same reference numbers and will not be described in detail.

The switch part 36 performs switching, in accordance with the detection information received by the communication part 22, between transmission of transmission information and reception of reception information. In association with each of different postures or movements of the mobile terminal device 100, it is determined in advance whether to transmit the transmission information or to receive the reception information. For example, it may be configured that the transmission information is transmitted from the information processing device 220 to the mobile terminal device 100 when the mobile terminal device 100 is inclined to be horizontally oriented, whereas the reception information is received from the mobile terminal device 100 when the mobile terminal device 100 is inclined to be vertically oriented. This allows the user to perform switching between transmission and reception of information with a simple operation of changing the posture or movement of the mobile terminal device 100.

When it is switched by the switch part 36 to transmit the transmission information, the control part 21 performs such control as to transmit the information displayed at the position on the display screen which is in contact with the mobile terminal device 100, as transmission information. In other words, with a simple operation by the user holding the mobile terminal device 100 and making it in contact with the position of the information displayed on the display screen, the information retained by the information processing device 220 can be transmitted to the mobile terminal device 100.

Furthermore, when it is switched by the switch part 36 to receive the reception information, the control part 21 performs such control as to display the reception information at the position on the display screen which is in contact with the mobile terminal device 100. In other words, with a simple operation of the user holding the mobile terminal device 100 and making it in contact with the display screen, the information processing device 220 can receive information retained by the mobile terminal device 100 and further display the received information at the position on the display screen which is in contact with the mobile terminal device 100.

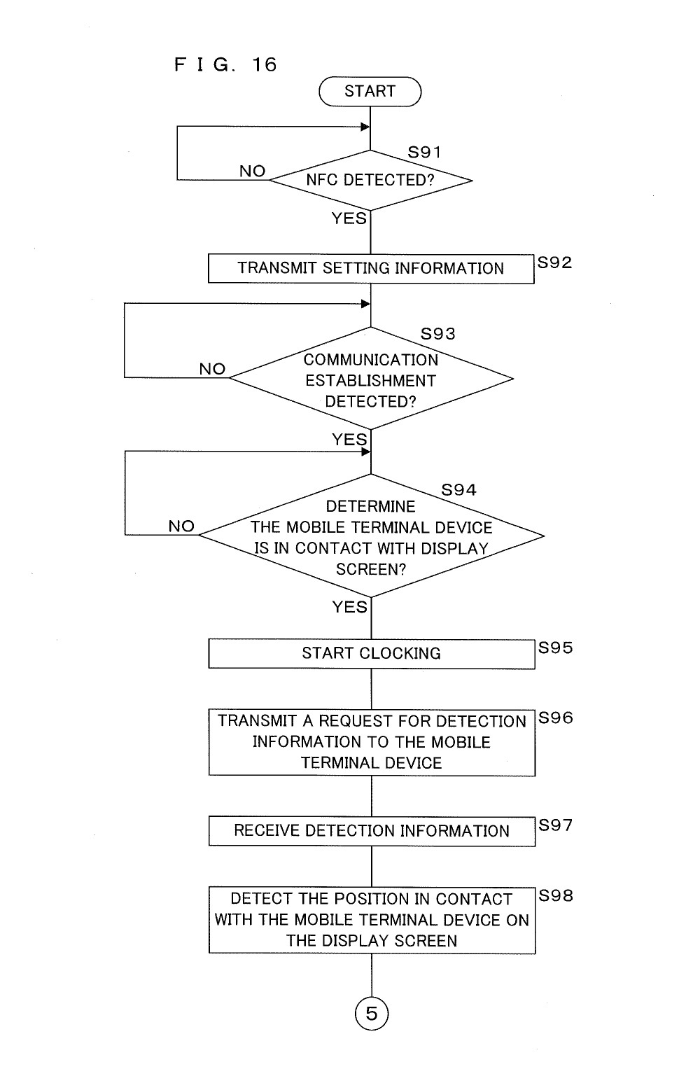

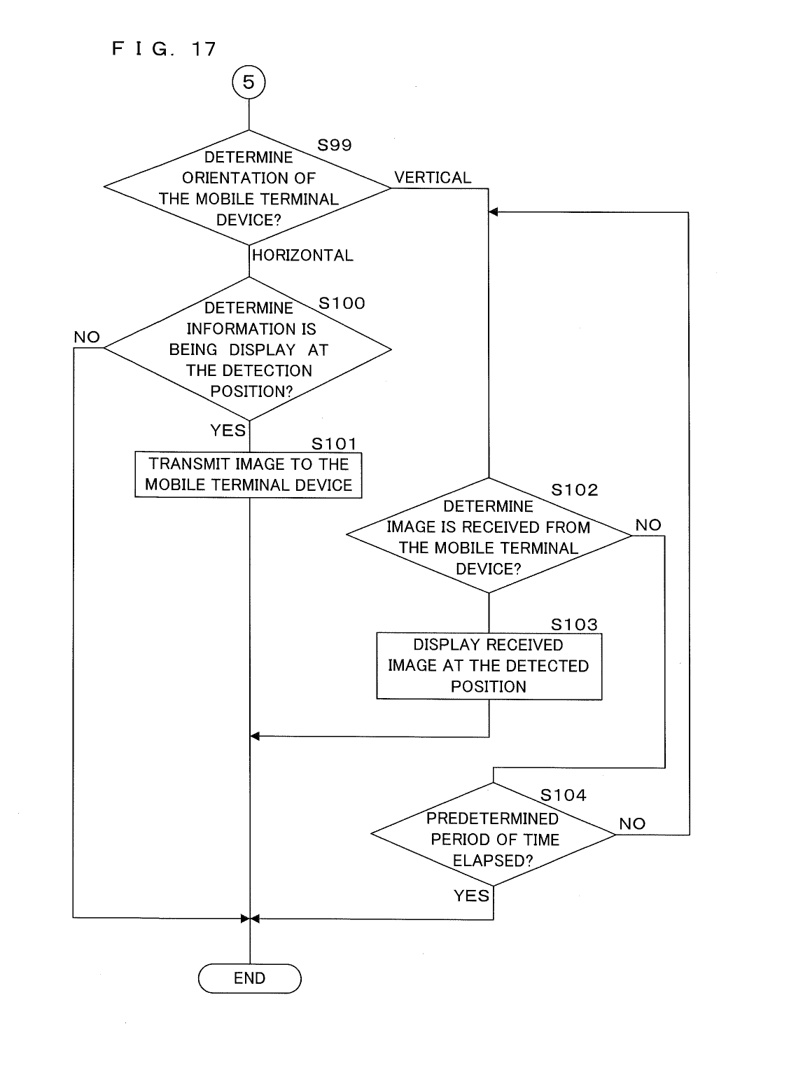

Next, the operation of an information processing system according to the third embodiment is described. FIGS. 16 and 17 show a flowchart illustrating an example of a processing procedure performed by the information processing device 220 according to the third embodiment. For the sake of convenience, the control part 21 is described as the subject of processing in the following description.

The control part 21 determines whether or not NFC detection is performed (S91). By the user moving the mobile terminal device 100 closer to the information processing device 220, the control part 21 can perform NFC detection. If NFC detection is not performed (NO at S91), the control part 21 continues the processing of step S91.

If NFC detection is performed (YES at S91), the control part 21 transmits setting information for performing short distance wireless communication such as Bluetooth (S92). The control part 21 determines whether or not the establishment of communication is detected (S93), and if the establishment of communication is not detected (NO at S93), continues the processing of step S93.

If the establishment of communication is detected (YES at S93), the control part 21 determines whether or not the mobile terminal device 100 is in contact with the display screen (S94). It is noted that the determination is not limited to be made based on the state of contact but may also be made based on the state of proximity. If the mobile terminal device 100 is not in contact with the display screen (NO at S94), the control part 21 continues the processing of step S94.

If the mobile terminal device 100 is in contact with the display screen (YES at S94), the control part 21 starts clocking (S95), transmits a request for detection information to the mobile terminal device 100 (S96), and receives the detection information transmitted by the mobile terminal device 100 (S97).

The control part 21 detects the position on the display screen which is in contact with the mobile terminal device 100 (S98). The control part 21 determines the orientation of the mobile terminal device 100 based on the received detection information (S99). If the orientation of the mobile terminal device 100 is horizontal (horizontal at S99), the control part 21 determines whether or not information is being displayed at the detected position on the display screen (S100).

If an image is being displayed at the detected position (YES at S100), the control part 21 transmits the image being displayed to the mobile terminal device 100 (S101), and terminates the processing. If no image is being displayed at the detected position (NO at S100), the control part 21 terminates the processing without performing the processing of step S101.

If the orientation of the mobile terminal device 100 is vertical (vertical at S99), the control part 21 determines whether or not an image is received from the mobile terminal device 100 (S102), and if an image is received (YES at S102), displays the received image at the detected position (S103) and terminates the processing.

If no image is received (NO at S102), the control part 21 determines whether or not a predetermined period of time has elapsed from the time when clocking is started (S104). If a predetermined period of time has not elapsed (NO at S104), the control part 21 performs the processing at and after step S102, and if the predetermined period of time has elapsed (YES at S104), terminates the processing.

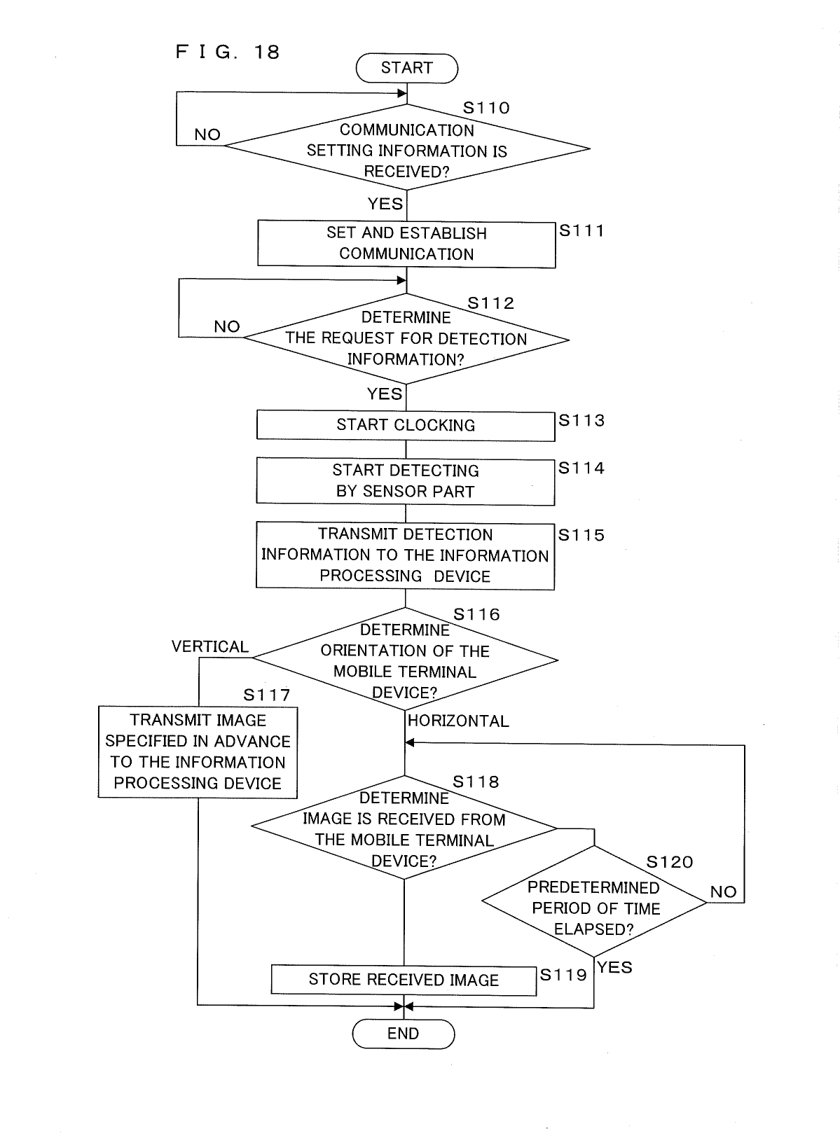

FIG. 18 is a flowchart illustrating an example of a processing procedure performed by the mobile terminal device 100 according to the third embodiment. For the sake of convenience, the control part 11 is described as the subject of processing in the following description. The processing shown in FIG. 18 corresponds to the processing shown in FIGS. 16 and 17.

The control part 11 determines whether or not communication setting information is received from the information processing device 220 (5110), and if the communication setting information is not received (NO at S110), continues the processing of step S110. If the communication setting information is received (YES at S110), the control part 11 sets and establishes the communication (S111), and determines whether or not a request for detection information is made from the information processing device 220 (S112).

If a request for detection information is not made (NO at S112), the control part 11 continues the processing of step S112. If a request for detection information is made (YES at S112), the control part 11 starts clocking (S113), and also starts detection of a predetermined physical quantity (e.g., the orientation of the mobile terminal device 100) by the sensor part 12 (S114). The control part 11 transmits the detection information obtained by detection performed by the sensor part 12 to the information processing device 200 (S115).

The control part 11 determines the orientation of the mobile terminal device 100 (S116), and if it is vertical (vertical at S116), transmits an image specified in advance to the information processing device 200 (S117) and terminates the processing. If the orientation of the mobile terminal device 100 is horizontal (horizontal at S116), the control part 11 determines whether or not an image is received from the information processing device 220 (S118).

If an image is received (YES at S118), the control part 11 stores the received image in the storage part 13 (S119) and terminates the processing. If no image is received from the information processing device 220 (NO at S118), the control part 11 determines whether or not a predetermined period of time has elapsed from the time at which clocking is started (S120). If the predetermined period of time has not elapsed (NO at S120), the control part 11 performs the processing at and after step S118, whereas if the predetermined period of time has elapsed (YES at S120), terminates the processing.

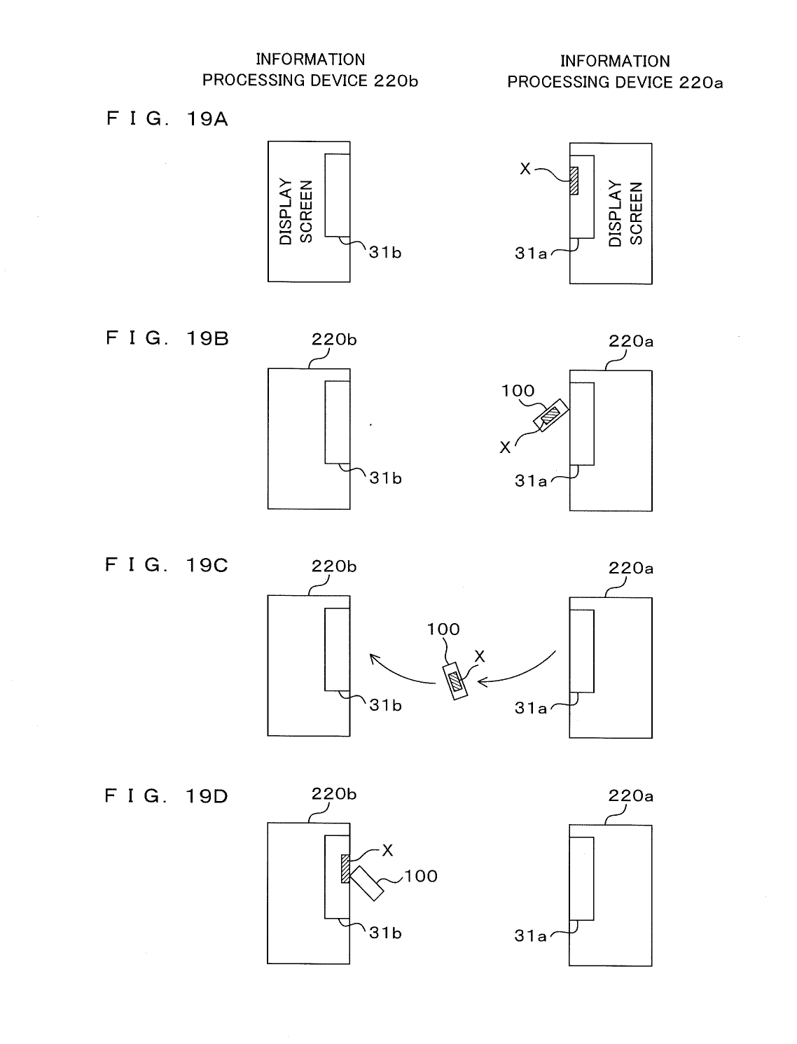

FIG. 19 is a schematic view illustrating an example of transmission/reception of information in the information processing system according to the third embodiment. As illustrated in FIG. 19, the information processing system includes information processing devices 220a, 220b, a mobile terminal device 100 and the like. It is assumed that the information processing devices 220a and 220b are distant from each other. As illustrated in FIG. 19A, assume that an image denoted by a reference character X is displayed on a display screen 31a of the information processing device 220a. It is noted that the displayed information is not limited to the image X.

As illustrated in FIG. 19B, when the user makes the mobile terminal device 100 in contact with the position where the image X is displayed on the display screen 31a with the mobile terminal device 100 being oriented horizontally to the displayed position of the image X, the information processing device 220a transmits the image X which is being displayed to the mobile terminal device 100. The mobile terminal device 100 stores the image X. It may also be configured that the image X is moved or copied to the mobile terminal device 100.

Next, when the user holds the mobile terminal device 100 and moves toward the information processing device 220b as illustrated in FIG. 19C, and makes the mobile terminal device 100 in contact with the display screen of the information processing device 220b, with the mobile terminal device 100 being oriented vertically with respect to the display screen, the mobile terminal device 100 transmits the stored image X to the information processing device 220b. The information processing device 220b receives the image X while displaying the received image X at the position which is in contact with the mobile terminal device 100 on the display screen 31b.

As described above, according to the first to third embodiments, by holding the mobile terminal device 100 near the information processing device, the information stored in the mobile terminal device 100 can be transmitted to the information processing device, or the information stored in the information processing device can be transmitted to the mobile terminal device 100. Furthermore, the operation of selecting a type of information to be transmitted and received may be facilitated according to the manner of holding the mobile terminal device 100 (orientation, for example).

The information processing system according to the present embodiment including a mobile terminal device (100) and an information processing device (200) capable of bidirectionally transmitting and receiving information through short distance communication is characterized in that the mobile terminal device includes: a detection part (12) detecting a physical quantity related to a posture or movement of the mobile terminal device itself; and a transmission part (14) transmitting detection information obtained by detection performed by the detection part to the information processing device, and that the information processing device includes: a reception part (22) receiving the detection information; and a specifying part (23) specifying transmission information to be transmitted to the mobile terminal device or reception information to be received from the mobile terminal device in accordance with the detection information received by the reception part.

An information processing device (200) according to the present embodiment capable of bidirectionally transmitting and receiving information to/from a mobile terminal device (100) through short distance communication is characterized by including: a reception part (22) receiving detection information related to a posture or movement of the mobile terminal device; and a specifying part (23) specifying transmission information to be transmitted to the mobile terminal device or reception information to be received from the mobile terminal device in accordance with the detection information received by the reception part.

According to the present embodiment, when the user holds the mobile terminal device (100) and changes its posture or moves it, the detection part (12) detects a physical quantity related to the posture or movement of the device itself. The detection part includes an inclination sensor, an acceleration sensor, a gyromagnetic sensor and the like, so as to detect, for example, the inclination, direction and orientation (e.g., vertical or horizontal) and the like as the posture of the mobile terminal device, and to detect, for example, the rotation direction, vibration amount, moving direction and the like as the movement of the mobile terminal device. The transmission part (14) transmits the detection information obtained by detection performed by the detection part to the information processing device (200). The detection information corresponds to the inclination, direction, orientation, rotation direction, vibration amount, moving direction and the like of the mobile terminal device.

The reception part (22) of the information processing device receives detection information transmitted by the mobile terminal device. The specifying part (23) specifies the transmission information to be transmitted to the mobile terminal device or the reception information to be received from the mobile terminal device in accordance with the detection information received by the reception part. The transmission information or reception information corresponds to information related to, for example, a document file, an image file, an address (e.g., WEB address, e-mail address, and network address), and a place of contact. Accordingly, in the case where information is transmitted from the information processing device to the mobile terminal device or where the information is received by the information processing device from the mobile terminal device, the information can be specified in accordance with the posture or movement of the mobile terminal device. This eliminates the need for the operations of, for example, moving a cursor, inputting a character or turning on/off a switch or the like, allowing the user to transmit and receive required information with a simple operation of merely changing the posture or movement of the mobile terminal device, which enhances the convenience for the user.

The information processing system according to the present embodiment is characterized in that the information processing device (200) includes: a display part (25) displaying a plurality of pieces of selection information respectively corresponding to a plurality of pieces of information; a selection part (26) selecting one of the plurality of pieces of selection information displayed on the display part in accordance with the detection information, and that the specifying part (23) specifies information corresponding to the selection information selected by the selection part as the transmission information or reception information.

According to the present embodiment, the display part (25) displays multiple pieces of selection information respectively corresponding to multiple pieces of information. When, for example, the information is a file, the selection information is a file name for selecting the file. That is, the display part may display menu information including multiple pieces of selection information for selecting multiple pieces of information. The selection part (26) selects one of the multiple pieces of selection information displayed on the display part in accordance with the detection information. In other words, the selection part can select the displayed pieces of selection information, in accordance with the posture or movement of the mobile terminal device.

The specifying part specifies the information corresponding to the selection information selected by the selection part as transmission information or reception information. Accordingly, when selecting required selection information among the displayed multiple pieces of selection information by changing the posture or movement of the mobile terminal device, the user can transmit information corresponding to the selected selection information to the mobile terminal device or can receive the same from the mobile terminal device. This allows the user to select required information with a simple operation while transmitting or receiving the selected information.

The information processing system according to the present embodiment is characterized in that the information processing device (200) includes: an information determination part (21) determining whether or not information necessary for required processing is present; and a request part (21) requesting the mobile terminal device (100) for specifying information for specifying the selection information if the information determination part determines that the necessary information is not present, that the mobile terminal device (100) is configured to transmit the specifying information to the information processing device when the request is made, that the information processing device is configured to further display selection information on the display part based on the specifying information transmitted by the mobile terminal device, and that the specifying part is configured to specify information corresponding to the selection information selected by the selection part as the reception information.

According to the present embodiment, the information determination part (21) determines whether or not information necessary for required processing is present. The information necessary for required processing corresponds to, for example, the information necessary for the operation to be executed by the user or for execution of a required application, which is determined in advance. The determination on the presence of information is to determine whether or not the information processing device stores (retains) the necessary information. If the information determination part determines that the necessary information is absent, the request part (21) requests the mobile terminal device for specifying information for specifying the selection information. The specifying information is the information for specifying selection information and can be used as selection information. The specifying information includes, for example, a folder name, a file name, an e-mail address, a place of contact, the number of options and the like.

When a request for specifying information is made, the mobile terminal device transmits the specifying information stored (retained) in advance to the information processing device. The information processing device then makes the display part display the selection information based on the specifying information transmitted by the mobile terminal device. For example, the information processing device can display the specifying information received from the mobile terminal device as the selection information. For example, when the information processing device receives multiple file names as specifying information, the received file names can be displayed as the selection information. When holding the mobile terminal device and changing its posture or moving it, the user can select desired selection information in accordance with the posture or movement. The specifying part specifies information corresponding to the selection information selected by the selection part as reception information. Accordingly, when the user performs required processing, by changing the posture or movement of the mobile terminal device and thereby selecting required selection information from the displayed multiple pieces of selection information, the user can receive information corresponding to the selected selection information from the mobile terminal device, even if the information is not retained in the information processing device.

The information processing system according to the present embodiment is characterized in that the information processing device (200) is configured to display selection information on the display part (25) if the information determination part (21) determines that necessary information is present, and that the specifying part (23) is configured to specify the information corresponding to the selection information selected by the selection part (26) as the transmission information.

According to the present embodiment, in the information processing device, when the information determination part determines that the necessary information is present, the selection information is displayed on the display part. That is, when the information processing device stores (retains) the information necessary for required processing, the specifying information retained by itself is displayed as the selection information. When holding the mobile terminal device and changing its posture or moving it, the user can select desired selection information in accordance with the posture or movement. The specifying part specifies the information corresponding to the selection information selected by the selection part as transmission information. Accordingly, when the user performs required processing, by changing the posture or movement of the mobile terminal device and thereby selecting required selection information from the displayed multiple pieces of selection information, the user can transmit information corresponding to the selected selection information to the mobile terminal device, even if the information is not retained in the mobile terminal device.

The information processing system according to the present embodiment is characterized in that the information processing device (210) includes a type specifying part (35) specifying a type of the transmission information in accordance with the detection information received by the reception part (22).

According to the present embodiment, the type specifying part (35) specifies a type of transmission information in accordance with the detection information received by the reception part (22). For example, as for the type of information, when the information is divided into a document file and an image file, different postures or movements of the mobile terminal device are set to be associated with a document file and an image file, respectively. For example, an image file may be associated when the mobile terminal device is inclined to be horizontally oriented, whereas a document file may be associated when the mobile terminal device is inclined to be vertically oriented. This allows the user to change the content of information to be transmitted with a simple operation by changing the posture or movement of the mobile terminal device.

The information processing system according to the present embodiment is characterized in that the information processing device (210) includes: a display part (31, 32) capable of detecting a position in contact with the mobile terminal device on a display screen; and a display determination part (34) determining whether or not information to be transmitted is being displayed at the position where the contact is made, and that the type specifying part (35) is configured to specify the type if the display determination part determines that the information is being displayed.

According to the present embodiment, the display part (31, 32) is configured to detect the position on the display screen which is in contact with the mobile terminal device. The display part may be a liquid-crystal display panel provided with a touch screen, or may be a touch screen device in which a light-emitting part and a light-receiving part are arranged around the display screen. The display determination part (34) determines whether or not the information to be transmitted is displayed at the position which is in contact with the mobile terminal device. If the display determination part determines that information is being displayed, the type specifying part specifies the type of transmission information. In other words, only with a simple operation by the user holding the mobile terminal device and making it in contact with the position of the information displayed on the display screen, the user can transmit different types of information to the mobile terminal device in accordance with the posture or movement of the mobile terminal device.

The information processing system according to the present embodiment is characterized in that the information processing device (220) includes a switch part (36) switching between transmission of the transmission information and reception of the reception information in accordance with the detection information received by the reception part (22).

According to the present embodiment, the switch part (36) performs switching, in accordance with the detection information received by the reception part (22), between transmission of transmission information and reception of reception information. In association with different postures or movements of the mobile terminal device, it is determined in advance whether to transmit the transmission information or to receive the reception information. For example, it may be configured that the transmission information is transmitted from the information processing device to the mobile terminal device when the mobile terminal device is inclined to be horizontally oriented, whereas the reception information is received from the mobile terminal device when the mobile terminal device is inclined to be vertically oriented. This allows the user to perform switching between transmission and reception of information with a simple operation of changing the posture or movement of the mobile terminal device.

The information processing system according to the present embodiment is characterized in that the information processing device (220) includes: a display part (31, 32) capable of detecting a position in contact with the mobile terminal device on a display screen; and a control part (21) performing, when the switch part (36) switches to transmit transmission information, such control as to transmit information displayed at the position in contact with the mobile terminal device as the transmission information.

According to the present embodiment, the display part (31, 32) is configured to detect the position on the display screen which is in contact with the mobile terminal device. The display part may be a liquid-crystal display panel provided with a touch screen, or may be a touch screen device in which a light-emitting part and a light-receiving part are arranged around the display screen. When the switch part (36) performs switching to transmit transmission information, the control part (21) performs such control as to transmit the information displayed at the position which is in contact with the mobile terminal device, as the transmission information. In other words, only with a simple operation by the user holding the mobile terminal device and making it in contact with the position of the information displayed on the display screen, the user can transmit information retained in the information processing device to the mobile terminal device.

The information processing system according to the present embodiment is characterized in that the control part (21) is configured to perform, when the switch part (36) switches to receive reception information, such control as to display the reception information at the position in contact with the mobile terminal device.

According to the present embodiment, when the switch part (36) performs switching to receive reception information, the control part (21) performs such control as to display the reception information at the position which is in contact with the mobile terminal device. In other words, only with a simple operation by the user holding the mobile terminal device and making it in contact with the display screen, the information processing device can receive the information retained by the mobile terminal device, and further makes the received information displayed at the position on the display screen which is in contact with the mobile terminal device.

Technical features described in the above embodiments of the present invention can form a new technical solution in combination with each other.

As this description may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An information processing system comprising a mobile terminal device and an information processing device, both the mobile terminal device and the information processing device capable of bidirectionally transmitting and receiving information through short distance communication,
wherein the mobile terminal device includes:
a detection part detecting a physical quantity related to a posture or movement of the mobile terminal device; and
a transmission part transmitting detection information obtained by detection performed by the detection part to the information processing device, and
wherein the information processing device includes:
a reception part receiving the detection information; and
a specifying part specifying transmission information to be transmitted to the mobile terminal device or reception information to be received from the mobile terminal device in accordance with the detection information received by the reception part.

2. The information processing system according to claim 1,
wherein the information processing device includes:
a display part displaying a plurality of pieces of selection information respectively corresponding to a plurality of pieces of information;
a selection part selecting one of the plurality of pieces of selection information displayed on the display part in accordance with the detection information, and
wherein the specifying part is configured to specify information corresponding to the selection information selected by the selection part as the transmission information or the reception information.

3. The information processing system according to claim 2,
wherein the information processing device includes:
an information determination part determining whether or not information necessary for required processing is present; and
a request part requesting the mobile terminal device for specifying information for specifying the selection information if the information determination part determines that the necessary information is not present,
wherein the mobile terminal device is configured to transmit the specifying information to the information processing device when the request is made,
wherein the information processing device is configured to further display the selection information on the display part based on the specifying information transmitted by the mobile terminal device, and
wherein the specifying part is configured to specify the information corresponding to the selection information selected by the selection part as the reception information.

4. The information processing system according to claim 3,
wherein the information processing device is configured to display the selection information on the display part if the information determination part determines that the necessary information is present, and
wherein the specifying part is configured to specify the information corresponding to the selection information selected by the selection part as the transmission information.

5. The information processing system according to claim 1,
wherein the information processing device includes a type specifying part specifying a type of the transmission information in accordance with the detection information received by the reception part.

6. The information processing system according to claim 5,
wherein the information processing device includes:
a display part capable of detecting a position in contact with the mobile terminal device on a display screen; and
a display determination part determining whether or not information to be transmitted is being displayed at the position in contact with the mobile terminal device, and
wherein the type specifying part is configured to specify the type if the display determination part determines that the information is being displayed.

7. The information processing system according to claim 1,
wherein the information processing device includes a switch part switching between transmission of the transmission information and reception of the reception information in accordance with the detection information received by the reception part.

8. The information processing system according to claim 7,
wherein the information processing device includes:
a display part capable of detecting a position in contact with the mobile terminal device on a display screen; and
a control part performing, when the switch part switches to transmit the transmission information, such control as to transmit information displayed at the position in contact with the mobile terminal device as the transmission information.

9. The information processing system according to claim 8,
wherein the control part is configured to perform, when the switch part switches to receive the reception information, such control as to display the reception information at the position in contact with the mobile terminal device.

10. An information processing device capable of bidirectionally transmitting and receiving information to/from a mobile terminal device through short distance communication, comprising:
a reception part receiving detection information related to a posture or movement of the mobile terminal device; and
a specifying part specifying transmission information to be transmitted to the mobile terminal device or reception information to be received from the mobile terminal device in accordance with the detection information received by the reception part.
